(19) United States
(12) Patent Application Publication
(10) Pub. No.: US 2018/0272961 A1
(43) Pub. Date: Sep. 27, 2018

(54) Decorative Fender Accessory

(71) Applicant: Michael L. Gust, Houston, TX (US)

(72) Inventor: Michael L. Gust, Houston, TX (US)

(21) Appl. No.: 14/704,162

(22) Filed: May 5, 2015

(51) Int. Cl. B60R 13/04

(52) U.S. Cl. CPC B60R 13/04

(57) ABSTRACT

The invention comprises a decorative fender accessory to a fix to the outside surface of a manufacturer's original fender to create the appearance of a custom off-road fender without the need to replace the original fender. Car specific. Limit the flare to no thicker than three-quarters inch. Aluminum, steel, acrylic, ABS, rigid or flexible materials. Twistable, rotatable, moldable in three dimensions,

### CROSS-REFERENCE TO RELATED APPLICATION

This application claims priority to U.S. provisional application No. 61/998,873 filed May 5, 2014 the contents of which are hereby incorporated by reference.

### BACKGROUND OF THE INVENTION

U.S. Pat. No. 6,695,367 issued to Shymkiw discloses method and apparatus for attaching a fender trim molding without drilling.

U.S. Pat. No. D386,736 issued to Madison discloses decorative fender molding that attaches underneath the fender.

The above referenced patents and patent applications are incorporated herein by reference in their entirety. Furthermore, where a definition or use of a term in a reference, which is incorporated by reference herein, is inconsistent or contrary to the definition of that term provided herein, the definition of that term provided herein applies and the definition of that term in the reference does not apply.

Although various decorative molding is known to the art, all, or almost all of them suffer from one or more than one disadvantage. Therefore, there is a need to provide a manufacturer specific decorative fender molding that is inexpensive and easily installed.

### SUMMARY OF THE INVENTION

The present invention relates in general to decorative fender molding. The current invention makes it possible for a vehicle owner to customize the appearance of their fenders. The decorative fender mold can easily be installed with adhesive, screws, bolts, or rivets or any combination thereof. The decorative fender mold can be made of various hard polymers like ABS. Other materials such as metal could be used and in particular aluminum. The decorative fender mold will preferably be quite thin at less than three-quarters inch of thickness; however, the thickness could be as great as three inches.

Also, the height of the decorative fender mold will preferably be one to three inches tall when measured orthogonal to the length of the fender although the height could range from one-half inch to five inches in height. Additionally, the decorative fender molding will have decorative bolts or rivets.

### BRIEF DESCRIPTION OF THE FIGURES

FIG. 1 is a side view of a preferred embodiment wherein the decorative fender mold is mounted adjacent to the vehicle fender and further comprises an aperture to accommodate a light on a vehicle fender.

FIG. 2 is a side view of a preferred embodiment wherein the decorative fender mold is mounted a quarter of an inch above the vehicle fender and further comprises an aperture to accommodate a light on the vehicle.

FIG. 3 is a front view of a preferred embodiment showing a profile that is adaptable to the manufacturer's fender profile while maintaining a flat outer surface.

FIG. 4 is a front view of a preferred embodiment showing a profile that is adaptable to the manufacturer's fender profile while maintaining a flat outer surface.

FIG. 5 is a front view of a preferred embodiment showing a profile that is adaptable to the manufacturer's fender profile while maintaining a flat outer surface.

FIG. 6 is a front view of a preferred embodiment showing a profile that is adaptable to the manufacturer's fender profile while maintaining a flat outer surface.

FIG. 7 is a front view of a preferred embodiment showing a profile that is adaptable to the manufacturer's fender profile while maintaining a flat outer surface.

FIG. 8 is a perspective view of a preferred embodiment wherein the decorative fender mold is mounted adjacent to the vehicle fender and further comprises an aperture to accommodate a light on the vehicle.

FIG. 9 is a side view of a preferred embodiment wherein the decorative fender mold is mounted a quarter of an inch above the vehicle fender and further comprises an aperture to accommodate a light on the vehicle.

FIG. 10 is a close up perspective view of a preferred embodiment wherein the decorative fender mold is mounted adjacent to the vehicle fender and further comprises an aperture to accommodate a light on the vehicle.

FIG. 11 is a close up perspective view of a preferred embodiment wherein the decorative fender mold is mounted a quarter of an inch above the vehicle fender and further comprises an aperture to accommodate a light on the vehicle.

FIG. 12 shows a cut through view of a preferred embodiment of the invention with a lip portion for installation.

FIG. 13 shows a close up of a clip for installation.

### DETAILED DESCRIPTION

The present invention relates in general to decorative fender mold. The current invention makes it possible for a vehicle owner to customize their original fender with the appearance of an aftermarket off-road fender for far less cost than replacing the original fender with an aftermarket custom off-road fender. The decorative fender mold can easily be installed with adhesive, screws, bolts, or rivets or any combination thereof. The decorative fender mold can be made of various hard polymers like ABS. Other materials such as metal could be used and in particular aluminum. The decorative fender mold will preferably be quite thin at less than three-quarters inch of thickness; however, the thickness could be as great as three inches. Also, the height of the decorative fender mold will preferably be one to three inches tall when measured orthogonal to the length of the fender although the height could range from one-half inch to five inches in height. Additionally, the decorative fender molding will have decorative bolts or rivets. Additionally, the decorative fender mold may optionally have an aperture to accommodate a light on the fender.

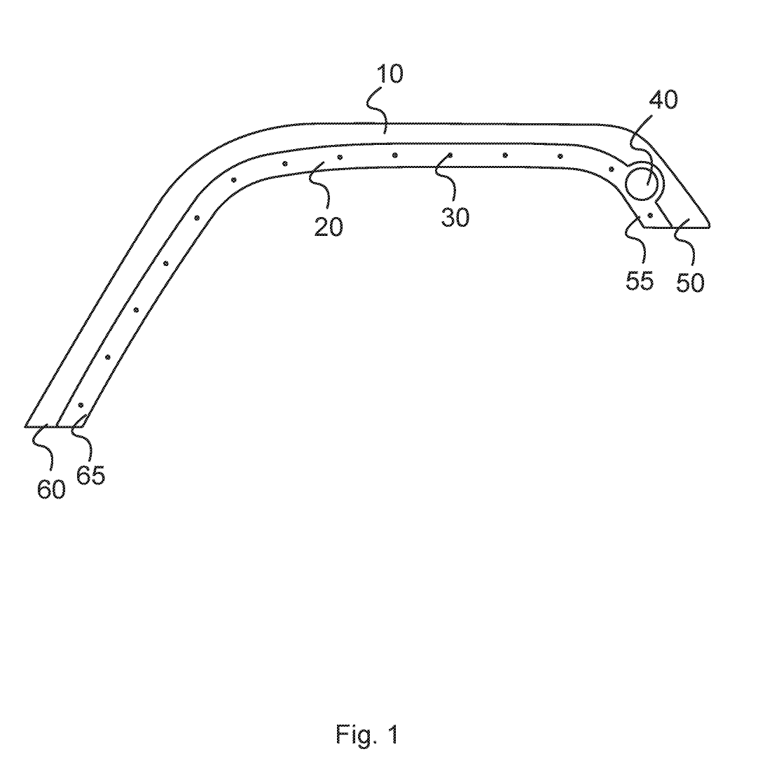

FIG. 1 illustrates a vehicle fender 10 with a distal end 50 and a proximal end 60. A decorative fender molding 20 has decorative portions 30 and an aperture 40 to accommodate a light fixture on a vehicle fender 10. The decorative fender molding 20 also has a distal end 55 and a proximal end 65. In this preferred embodiment the decorative fender molding 20 distal end 55 is adjacent the vehicle fender 10 distal end 50. Also, in this preferred embodiment the decorative fender molding 20 proximal end 65 is adjacent the vehicle fender 10 distal end 60. In this embodiment there is no gap between the decorative fender molding 20 and the bottom portion of the vehicle fender 10. The aperture 40 is intended as an optional feature for vehicles that are designed with blinkers or other light fixtures affixed to the vehicle fender 10. The aperture 40 can be of any size and shape.

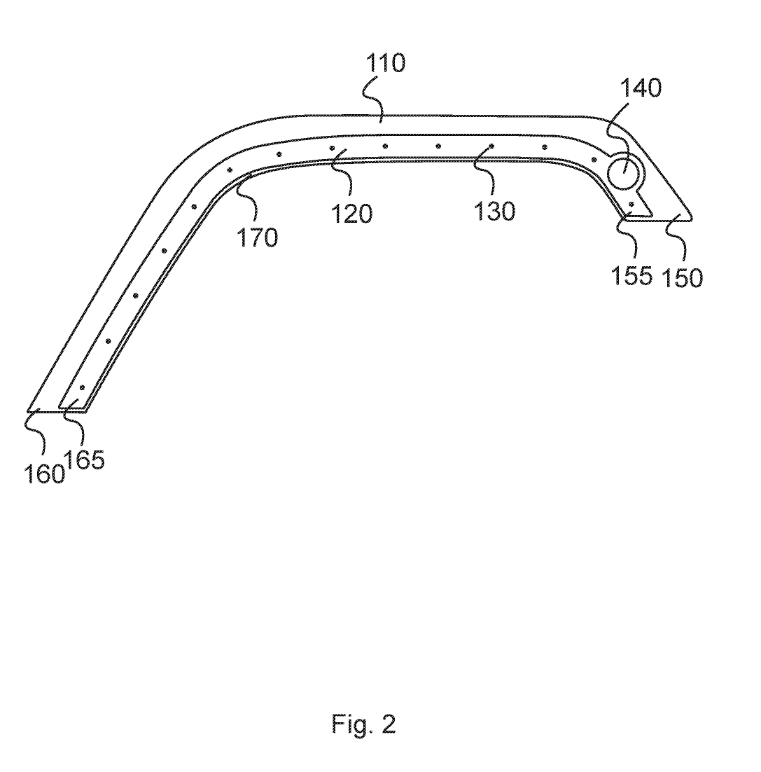

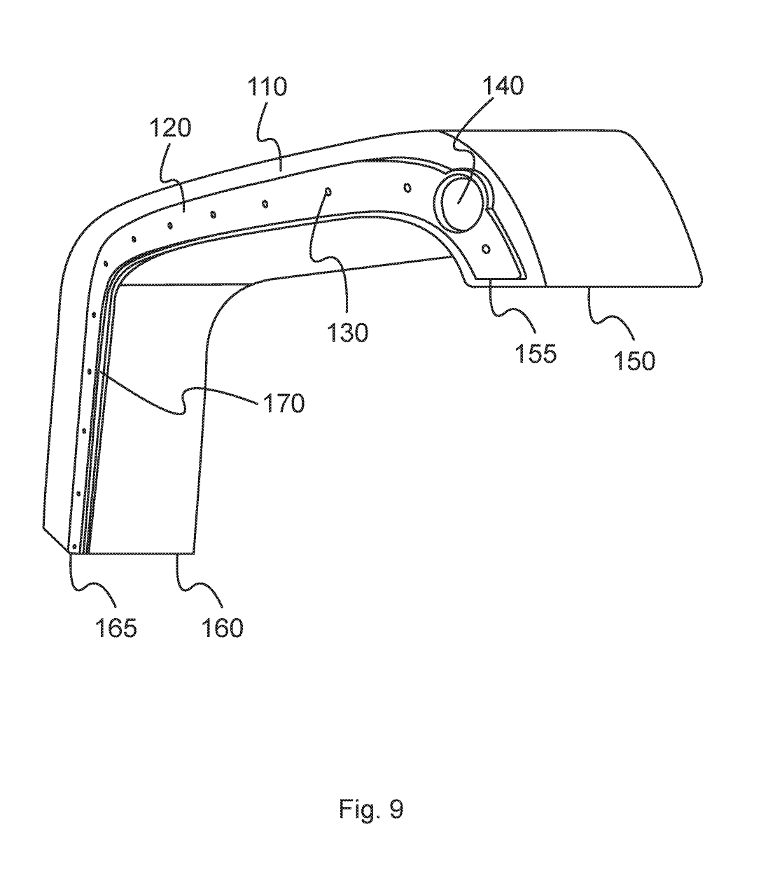

FIG. 2 illustrates a vehicle fender 110 with a distal end 150 and a proximal end 160. A decorative fender molding 120 has decorative portions 130 and an aperture 140 to accommodate a light fixture on a vehicle fender 110. The decorative fender molding 120 also has a distal end 155 and a proximal end 165. In this preferred embodiment the decorative fender molding 120 distal end 155 has a gap (see FIG. 9 #170) so that portions of vehicle fender 110 are visible surrounding the decorative fender molding 120.

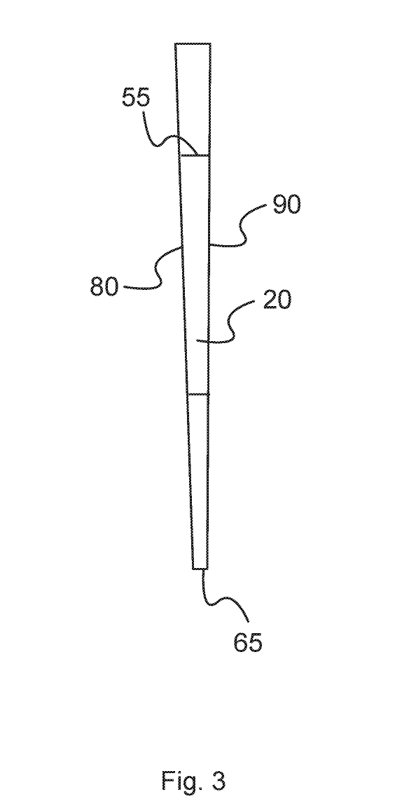

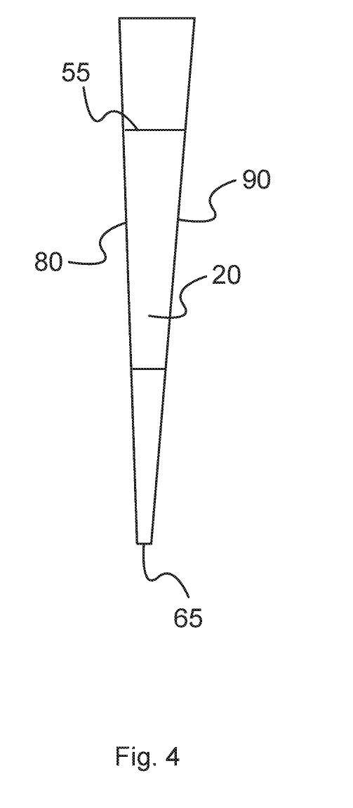

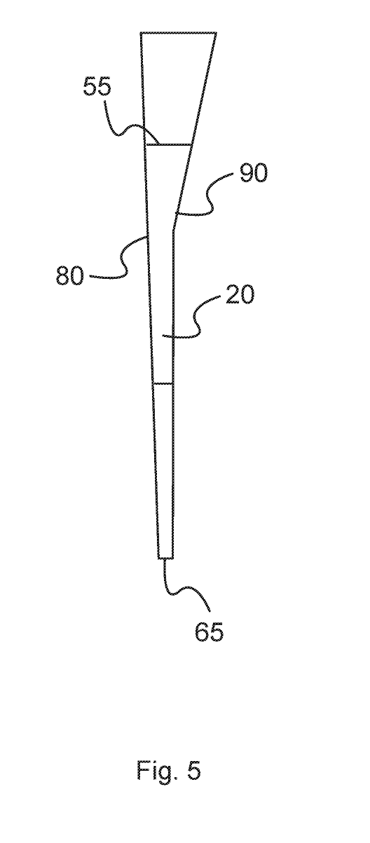

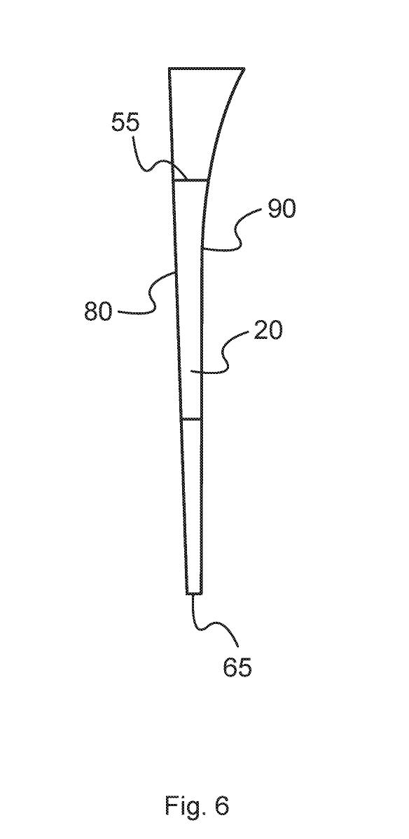

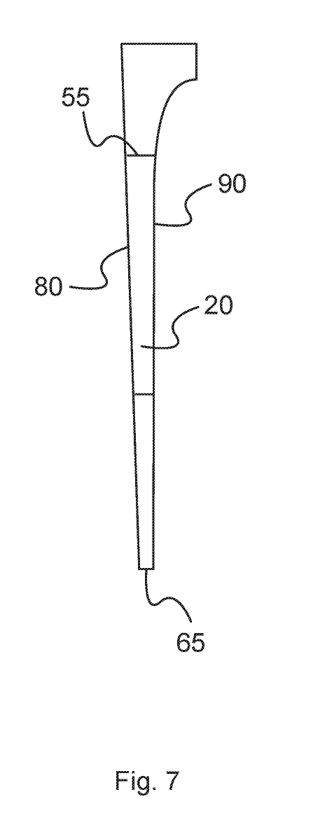

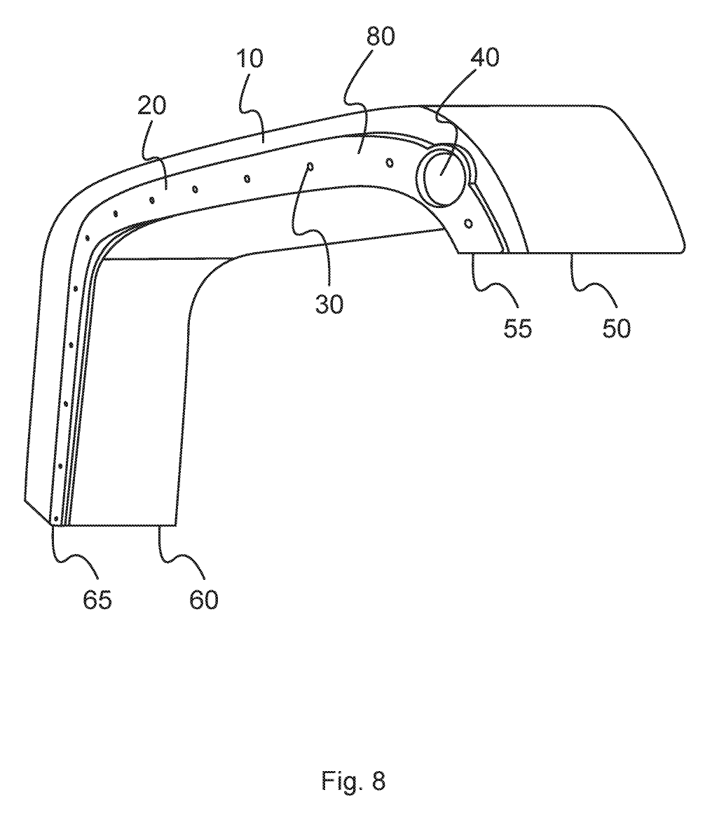

FIGS. 3-7 illustrate various profiles of the decorative fender molding 20 profiles. For example, the profile is adaptable to the manufacturer's fender profile while maintaining a flat outer surface 80. The manufacturer's fender profile would complement the inner surface 90 of the decorative fender molding 20. The purpose of a complementary inner surface 90 would be to allow the outer surface 80 make the decorative fender molding 20 ninety degrees from the ground. Alternatively, the decorative fender molding 20 could be of uniform thickness. The profile thickness can be from 0.1 millimeter up to 25 millimeters with a preferred embodiment of profile thickness between 8-18 millimeters. The height of the decorative fender molding 20 is between 10 millimeters and 100 millimeters, with a preferred embodiment of 20-50 millimeters. For the sake of clarity, it is intended that the height be measured orthogonally from the length of the decorative fender molding 20. To the extent that an aperture 40 is incorporated into decorative fender molding 20 the orthogonal height may be greater than 100 millimeters. In the event that the aperture 40 height were greater than 100 millimeters the limitations disclosed herein would still apply while taking into account the height of the aperture 40 by adding the height of the aperture to the measured height of the decorative fender molding 20. The decorative portion 30 is intended to be of various thickness and shapes. In a preferred embodiment the decorative portion 30 is a bolt, rivet or screw that can be made of plastic or metal and can be painted or machined for ornamental purposes. For example, a decorative fender molding 20 could be painted a contrasting color from the vehicle fender 10 and the decorative portion could color match the vehicle fender 10. Alternatively, a decorative fender molding 20 could be painted a color match to the vehicle fender 10 and the decorative portion could be painted a contrasting color from the vehicle fender 10. In another embodiment the decorative fender molding 20 and the decorative portion 30 could be painted or machined any matching or non-matching colors. FIG. 8 is a perspective view of a vehicle fender 10 with a distal end 50 and a proximal end 60. A decorative fender molding 20 has decorative portions 30 and an aperture 40 to accommodate a light fixture on a vehicle fender 10. The decorative fender molding 20 also has a distal end 55 and a proximal end 65. In this preferred embodiment the decorative fender molding 20 distal end 55 is adjacent the vehicle fender 10 distal end 50. Also, in this preferred embodiment the decorative fender molding 20 proximal end 65 is adjacent the vehicle fender 10 distal end 60. In this embodiment there is no gap between the decorative fender molding 20 and the bottom portion of the vehicle fender 10.

FIG. 9 is a perspective view of a vehicle fender 110 with a distal end 150 and a proximal end 160. A decorative fender molding 120 has decorative portions 130 and an aperture 140 to accommodate a light fixture on a vehicle fender 110. The decorative fender molding 120 also has a distal end 155 and a proximal end 165. In this preferred embodiment the decorative fender molding 120 distal end 155 has a gap 170 so that portions of vehicle fender 110 are visible surrounding the decorative fender molding 120. Alternatively, in the current embodiment the gap 170 would be closed off if the decorative fender molding 120 distal end 155 and proximal end 165 were adjacent the vehicle fender 110 distal end 150 and proximal end 160, respectively.

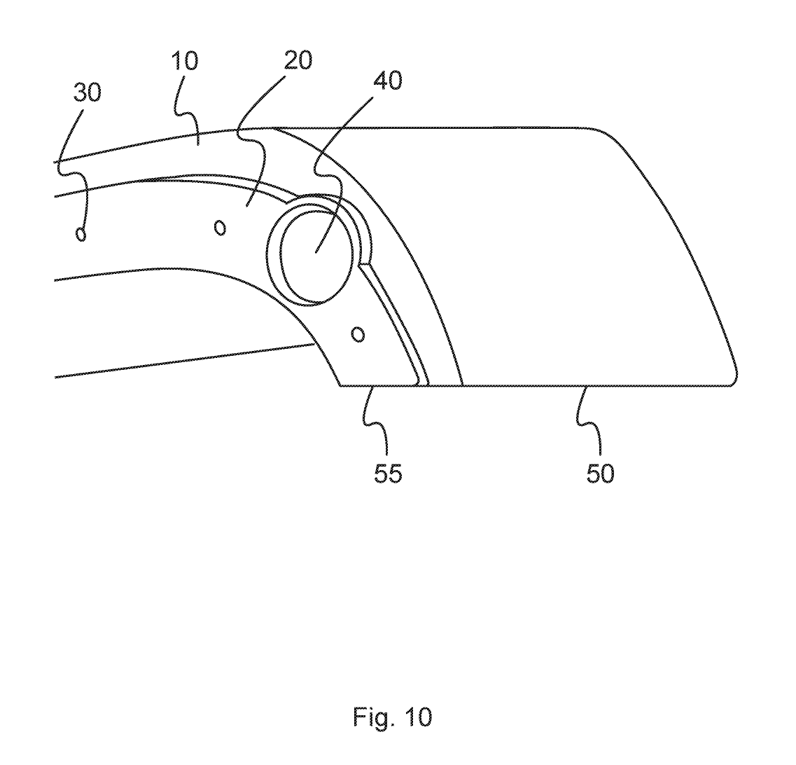

FIG. 10 is a close up perspective view of a vehicle fender 10 with a distal end 50. A decorative fender molding 20 has decorative portions 30 and an aperture 40 to accommodate a light fixture on a vehicle fender 10. The decorative fender molding 20 also has a distal end 55. In this preferred embodiment the decorative fender molding 20 distal end 55 is adjacent the vehicle fender 10 distal end 50. In this embodiment there is no gap between the decorative fender molding 20 and the bottom portion of the vehicle fender 10.

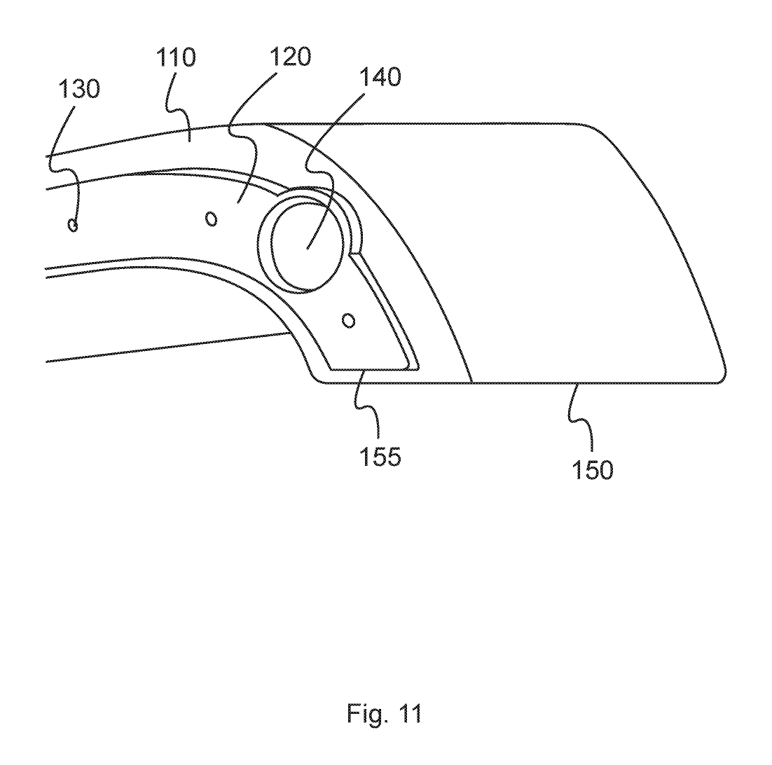

FIG. 11 is a close up perspective view of a vehicle fender 110 with a distal end 150. A decorative fender molding 120 has decorative portions 130 and an aperture 140 to accommodate a light fixture on a vehicle fender 110. The decorative fender molding 120 also has a distal end 155. In this preferred embodiment the decorative fender molding 120 distal end 155 has a gap 170 so that portions of vehicle fender 110 are visible surrounding the decorative fender molding 120.

Alternatively, in the current embodiment the gap 170 would be closed off if the decorative fender molding 120 distal end 155 and proximal end 165 (not shown) were adjacent the vehicle fender 110 distal end 150 and proximal end 160 (not shown), respectively.

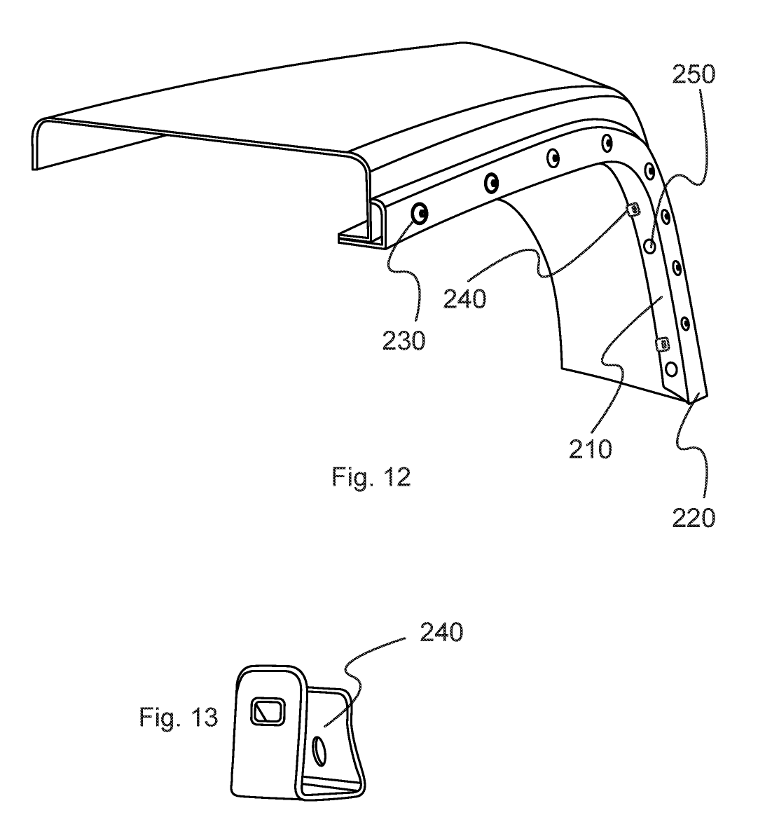

FIGS. 12-13 show a preferred embodiment of the invention 200. The decorative fender molding 220 has a lip portion 210 that wraps under a fender. The decorative fender has decorative portions 230 and is attached to the fender via clips 240. The dimensions of this preferred embodiment 220 are similar to the above described embodiments except for the lip portion 220 which can extend under the fender up to three inches but preferably about one inch. Alternatively, the fender molding 220 could be attached with other known conventional attachment methods using bolts, screws, adhesives, for example. A hole 250 can be placed in the lip portion 210 for different attachment methods.

Each of the embodiments are capable of being made of polymer that is rigid or flexible so that it matches the original manufacturer fender. Alternatively, the embodiments can be made of metal such as aluminum, for example.

While the foregoing description sets forth various examples and details relating to preferred embodiments, it should be appreciated that the description is illustrative only and should not to be construed as limiting the invention. Thus, the scope of this disclosure is not to be limited by the illustrations or the foregoing descriptions thereof, but rather solely by the appended claims.

What is claimed is:

1. A decorative fender mold that may be attached to a fender with a bolt, rivet, screw, and adhesive.

2. The decorative fender mold according to claim 1, wherein the mold is attached adjacent to a vehicle fender.

3. The decorative fender mold according to claim 1, wherein the mold is attached 0.25 inch-0.75 inch above a vehicle fender.

4. The decorative fender mold according to claim 1, wherein the mold is attached adjacent to a vehicle fender and the decorative fender mold is less than three inches tall and more than 0.25 inches tall.

5. A decorative fender mold with a lip portion for attachment to an original vehicle fender.

6. The decorative fender mold of claim 5, wherein the mold is attached with a clip, bolt, rivet, screw, and adhesive.

7. The decorative fender mold of claim 5, wherein the lip portion is between one and three inches.
